(19) United States
(12) Patent Application Publication
(10) Pub. No.: US 2003/0161572 A1
(43) Pub. Date: Aug. 28, 2003

(54) Integrated optical waveguides for microfluidic analysis systems

(76) Inventors: Matthias Johnck, Munster (DE); Thomas Greve, Darmstadt (DE); Gunter Hauke, Muhtal (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/311,287

(22) PCT Filed: May 22, 2001
(86) PCT No.: PCT/EP01/05843

(30) Foreign Application Priority Data
Jun. 17, 2000 (DE) 100 29 946.6

(51) Int. Cl. G02B 6/12

(52) U.S. Cl. 385/14

(57) ABSTRACT

The invention relates to microstructured, miniaturised, polymer-based analysis systems having integrated optical polymer light waveguides for optical detection methods, and process for the production thereof

The invention relates to microstructured, miniaturised, polymer-based analysis systems having integrated optical polymer light waveguides for optical detection methods, and processes for the production thereof.

Microfluidic analysis methods are known, in particular, in the area of capillary electrophoresis (CE). Besides “classical” CE using quartz capillaries, so-called “chip technologies” (using planar, microstructured analysis units), in particular, have been the subject-matter of numerous investigations and developments.

Very frequently used detection methods in CE are, for example, optical absorption or fluorescence detection. Absorption measurement in the UV range is significantly inferior to fluorescence measurement, in particular laser-induced fluorescence measurement (LIF), with regard to sensitivity due to the restriction by the short optical path length (internal diameter of the capillary). Numerous suitable arrangements for fluorescence and absorption measurement in quartz capillaries have been described. In general, a common feature thereof is that they direct optical power directly to or from the capillary via optical fibres. In EP 0 616 211 A1, for example, excitation light is supplied to a capillary through a material having a relatively high optical refractive index. Fluorescence light is fed from this capillary to a detector via optical fibres connected directly to the capillary.

Hashimoto et al. (M. Hashimoto, K. Tsukagoshi, R. Nakajima, K. Kondo, “Compact detection cell using optical fiber for sensitisation and simplification of capillary electrophoresis-chemiluminescence detection”, J. of Chromatography A, 832, 1999, 191-202) have produced a chemiluminescence detector likewise by means of optical fibres, which are, however, installed directly before the capillary outputs. An alternative procedure is direct positioning of the optical emitter and receiver before and after the capillary respectively.

For use in planar, microstructured, miniaturised analysis units, both of the above-mentioned procedures are of only limited suitability since it is difficult to move the optical fibres or emitter and receiver units into the direct vicinity of the channels.

The chip CE detection method is therefore generally carried out using laser-induced fluorescence measurement. To this end, laser light is focused on the fluid channel via a free space optical system, and the emission is likewise measured by means of a free space optical system. However, this represents a major restriction of the detection methods for planar, microstructured analysis units.

The object of the present invention was therefore to make other detection methods, such as, for example, absorption measurement, also available for planar, microstructured, miniaturised analysis units.

It has been found that optical power can be directly supplied to or removed from the channels of the analysis units via optical fibres by integrating optical light waveguides directly into the analysis units during the production process. The supply or output of optical power to or from the system can thus be ensured in a simple manner. Microfluidic structures here can be in direct or indirect contact with the optical structure. The further production processes of microstructured, polymer-based systems can be combined with the production of the optical structures or do not impair the latter.

The present invention therefore relates to planar, microstructured, miniaturised, polymer-based analysis units containing integrated, optical polymer light waveguides.

In a preferred embodiment, the substrate (2) and cover (4) of the analysis unit consist of PMMA.

In a preferred embodiment, the substrate is microstructured and the cover has thin-film electrodes.

The present invention also relates to a process for the production of microstructured, miniaturised, polymer-based analysis units containing integrated, optical polymer light waveguides, where

a) suitable polymer-based components are provided;

b) the optical polymer light waveguides are integrated into at least one component;

c) the components are assembled to form an analysis unit.

In a preferred embodiment, the integration of the polymer light waveguides in step b) is carried out by multicomponent injection moulding.

In a preferred embodiment, the assembly of the components in step c) is carried out by

i) wetting at least one component with adhesive in such a way that, after assembly of the components, the interior of the channel system produced by the microstructuring is not covered with adhesive;

ii) adjusting the components;

iii) pressing the components together;

iiii) curing the adhesive.

The present invention also relates to the use of the microstructured, polymer-based analysis units which contain integrated optical polymer light waveguides for the optical analysis of samples.

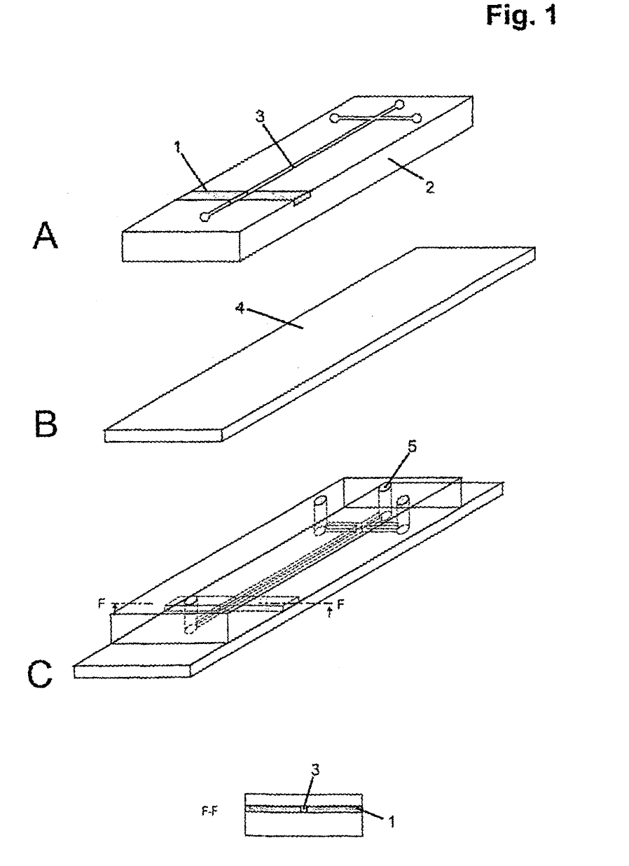

FIG. 1 shows a microstructured analysis unit with integrated optical light waveguides.

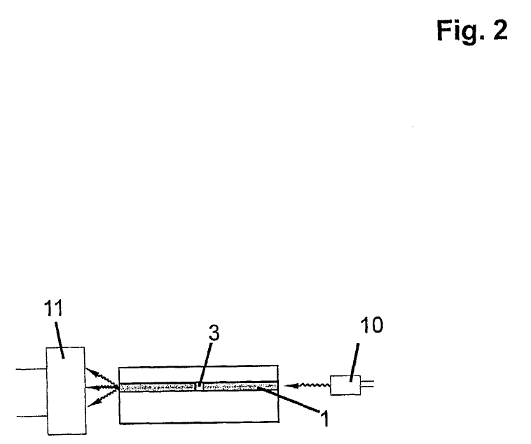

FIG. 2 shows the ray path of an absorption measurement using an analysis unit corresponding to FIG. 1.

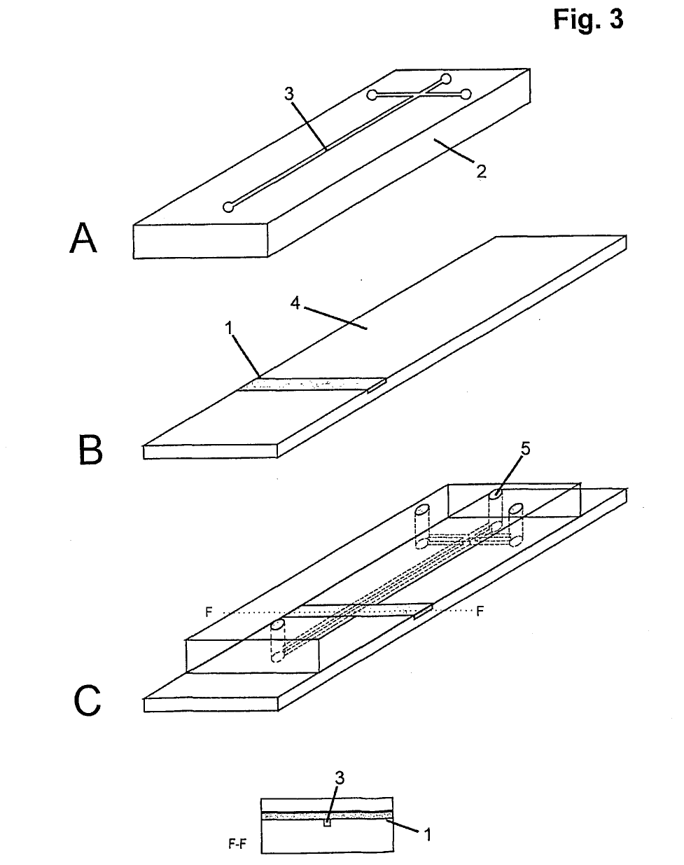

FIG. 3 shows an alternative microstructured analysis unit with integrated optical light waveguides.

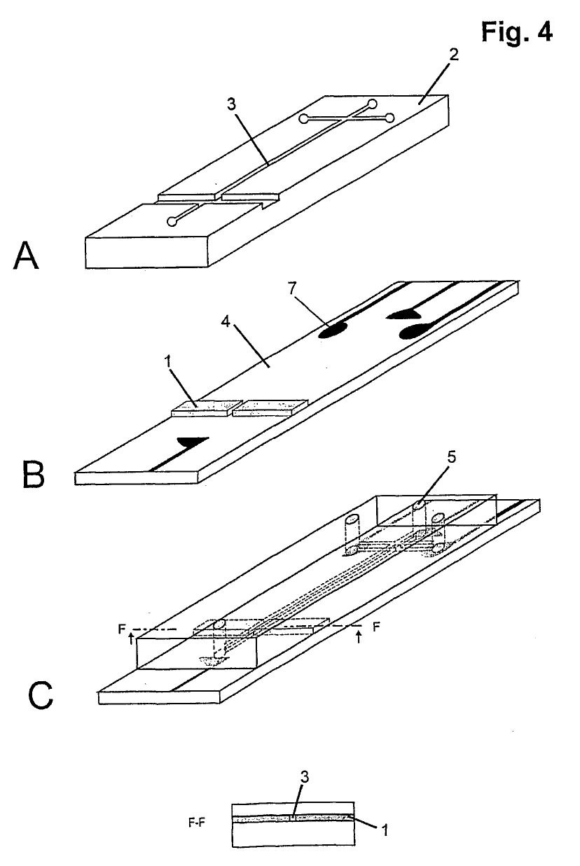

FIGS. 4 to 7 illustrate processes for the production of the microstructured analysis units according to the invention with integrated light waveguides.

In all figures, the constituents of the analysis units are denoted by the following numbers:

The analysis unit consists of a substrate (2) and a cover (4). The substrate (2) has a channel structure (3). The optical waveguides are denoted by 1. If electrodes have been applied to a component, these are denoted by 7. Holes for, for example, fluid connections are denoted by 5. In FIGS. 1, 3, 4, 5, 6 and 7, part A of the figure shows the substrate, part B of the figure shows the cover and part C of the figure shows the analysis unit assembled from the two components, substrate and cover. In addition, FIGS. 1, 3, 4, 5 and 6 each show a side view along the axis F indicated in part A or C of the figure.

The other numbers are explained in the explanation of the respective figure.

The novel combination of integrated optical waveguides with a microstructured, fluid analysis unit is shown diagrammatically in FIGS. 1 and 2. For the purposes of the invention, planar, microstructured analysis units generally consist of at least two components, for example a substrate and a cover. All components can have microstructuring, electrodes or other additional functionalities. However, the analysis system contains at least one channel system formed by microstructuring of at least one component. In addition, the components can have further microstructuring, such as, for example, recesses for the integration or connection of the functionalities, such as valves, pumps, reaction vessels, detectors, etc., reservoirs, reaction chambers, mixing chambers, detectors, etc., incorporated into the components. The analysis systems according to the invention can be provided with all functionalities which are necessary for carrying out an analysis. It is just as possible for the analysis systems to have merely the channel structure, the integrated, optical light waveguides according to the invention and connections for further functionalities. In this case, the analysis systems must be provided with all requisite functionalities before use. The microstructured analysis systems according to the invention serve for the analysis of microfluidic systems, i.e. liquid systems and/or plasma processes, such as, for example, in the case of a miniaturised microwave or direct-current plasma.

As shown in FIG. 1, only one component, the substrate 2, preferably contains the microstructured recesses for the later channels (part A of the figure). The open structures in the substrate are sealed in a liquid- or gas-tight manner by means of the second component, the cover 4 (part B of the figure). The electrodes, if present, are usually applied to the cover. The microstructured channels are filled through holes or cut-outs 5, which are generally likewise integrated into the substrate.

The components of the analysis units preferably consist of commercially available thermoplastics, such as PMMA (polymethyl methacrylate), PC (polycarbonate), polystyrene or PMP (polymethylpentene), cycloolefinic copolymers or thermosetting plastics, such as, for example, epoxy resins. More preferably, all components, i.e. substrates and cover, of a system consist of the same material.

The optical waveguide 1 can be integrated either into the substrate (FIGS. 1, 5, 6 and 7) or into the cover (FIGS. 3 and 4). The waveguide geometry is variable in broad limits and can be matched to the cross sections of the channel structure and the coupling conditions (light source, detector). The optical properties of the waveguide, such as, for example, attenuation and numerical aperture, are determined by the materials of substrate and/or cover and waveguide.

Whereas the arrangement of the waveguide shown in FIG. 1 is particularly suitable for fluorescence and absorption measurements, the arrangement shown in FIG. 3 is, for example, particularly suitable for fluorescence measurements.

FIG. 2 shows the ray path of an absorption measurement using an analysis unit corresponding to FIG. 1. Starting from the light source 10, optical power is introduced into the waveguide. Depending on the distance between waveguide end face and light source and depending on the divergence of the light source, it may be necessary to add a lens for the introduction of light. In particular in the case of LEDs and SLEDs, a lens generally has to be used owing to their high divergence. The optical power exiting from the waveguide is, after passing through the fluid located in the channel 3, detected with the aid of the detector 11, typically a photomultiplier.

The wavelength range that can be used is determined by the absorption characteristics of the waveguide and substrate materials.

For fluorescence measurements, the waveguide must not be positioned on both sides of the channel. A mirror surface or lens surface which enables 90° deflection of light or focusing respectively can equally be integrated into the waveguides with the aid of casting technology. This enables the supply and output of the optical power to and from the fluid channel to be optimised for various applications.

The fluorescence in channel 3 can be excited by supplying the optical power needed for the excitation through the waveguide. However, supply at a 90° angle to the direction in which the embedded optical waveguides run is more suitable, since significantly fewer scattered-light effects of the excitation light then have to be masked out by optical filters for detection.

Polymer-based light waveguide components are known in sufficient number. Besides single-mode and multimode integrated optical components, such as optical splifters, thermo-optical switches and wavelength multiplexers, these include, in particular, so-called POFs (polymer optical fibres). The production of integrated optical components can be divided into a number of technology fields:

photobleaching (M. B. J. Diemer, F. M. M. Suyten, E. S. Trommel, A. McDonach, J. M. Copeland, L. W. Jenneskens, W. H. G. Horsthuis, “Photo-induced channel waveguide formation in nonlinear optical polymers,” Electron. Lett. 26, 379-380, 1990./van der Vorst et al. in “Polymers for lightwave and integrated optics”, (Ed. L. A. Hornak), Marcel Dekker Inc., New York, 365-395, 1992),

photolocking (E. A. Chandross, C. A. Pryde, W. J. Tomlinson, H. P. Weber, “Photolocking—A new technique for fabricating optical waveguide circuits”, Appl. Phys. Left. 24, 72-74, 1974./B. L. Booth, “Low loss channel waveguides in polymers,” J. Lightwave Techn. 7, 1445-1453, 1989),

selective photopolymerisation (R. R. Krchnavek, G. R. Lalk, D. H. Hartmann, “Laser direct writing of channel waveguides using spin-on polymers”, J. Appl. Phys. 66 (11), 5156-5160, 1989,

reactive ion etching (R. Yoshimura, M. Hikita, S. Tomaru, S. Imamuar, “Low-loss polymeric optical waveguides fabricated with deuterated poly-fluoromethacrylate”, J. Lightw. Techn. 16 (6), 1030-1037, 1998),

replication technologies (A. Neyer, T. Knoche, L. Muller, “Fabrication of low-loss polymer waveguides using injection moulding technology,” Electron. Lett. 29, 399-401,1993)

and other methods (Y. Y. Maruo, S. Sasaki, T. Tamamura, “Embedded channel polyimide waveguide fabrication by direct electron beam writing method,” J. Lightwave Technol. 13, 1718-1723, 1995./R. Moosburger, K. Petermann, “4×4 digital optical matrix switch using polymeric oversized rib waveguides,” IEEE Photonics Technology Lett. 10, 684-686,1998).

Replication technologies include combination of casting technology (for example injection moulding, hot embossing, reaction casting) for the production of inexpensive light waveguide structures with adhesive methods. Accordingly, the waveguides are formulated by filling trenches in polymers with adhesives which can be polymerised both thermally (for example by means of reaction casting) and photochemically (UV radiation). The polymers formed in the process have a higher refractive index than the substrate or cover material and thus form the light waveguides.

Two-component injection moulding for the production of optical waveguide components is a further method and has hitherto only been suitable for the production of multimode waveguides. The process is described in Groh (EP 0451549 A2) and Fischer (D. Fischer, “Mehrmodige integriertoptische Wellenleiterschaltungen aus Polymeren” [Multimode integrated optical waveguide switches made from polymers], Fortschritt-Berichte, VDI Verlag, Series 10, No. 477). By means of this technology, the waveguides can be incorporated both into the cover and into the substrate.

For the production of the analysis units according to the invention with integrated optical polymer light waveguides, firstly provision is made for components of appropriate design, of which at least one component is microstructured. Depending on the process used for introducing the waveguides, the components may additionally be prepared for integration of the optical structures by microstructuring or other pre-treatment. This is then followed by integration of the optical polymer light waveguides. In general, the polymer light waveguide is only integrated into one of the components. The components are subsequently assembled using suitable methods, preferably an adhesive process.

The integration of the optical, polymer-based structure into the components of the microstructured, polymer-based analysis unit can be carried out by various methods:

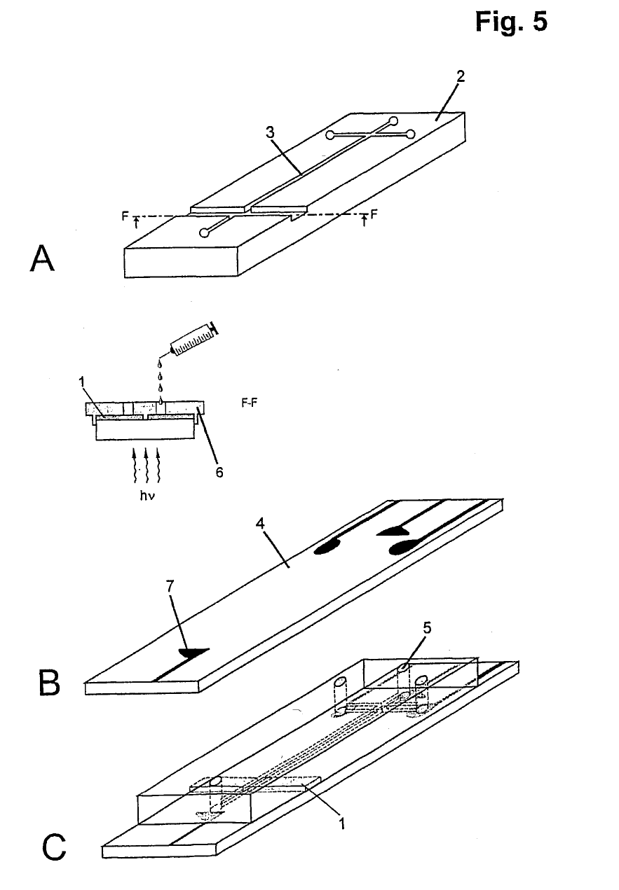

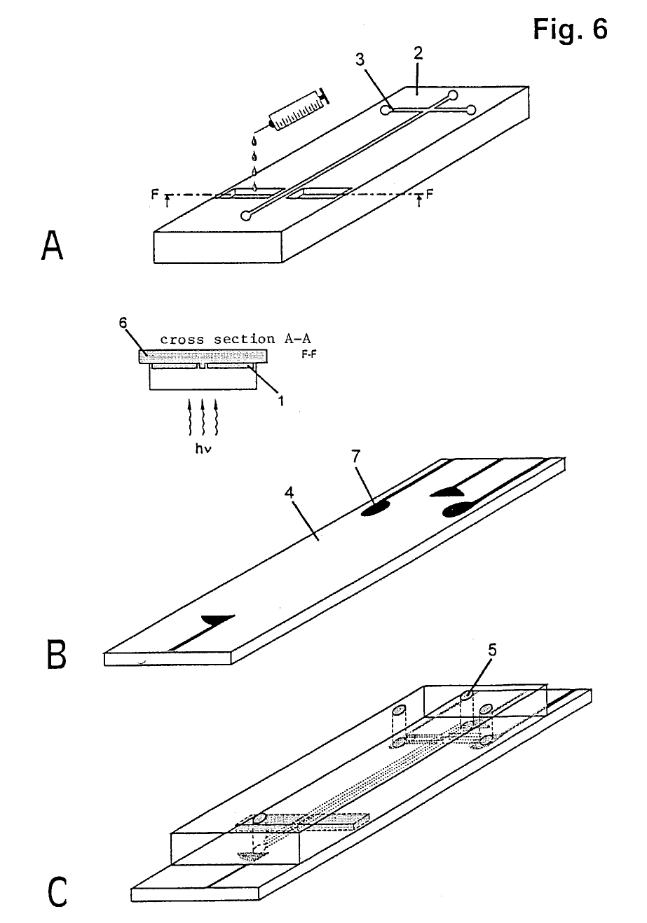

1.) Production in Accordance with FIGS. 5 and 6

These figures additionally show the combination with thin-film electrodes 7 for detection purposes or as power electrode for fluid transport (electrokinetic flow). In an injection-moulding, hot-embossing or reaction-casting process, both the fluid and the optical structures (channels in, for example, PMMA) are incorporated into a polymeric support, referred to as substrate below, in a casting step. The optical structures are then produced by filling the trenches provided for guiding the optical waveguide with a material of higher optical refractive index. On filling of the waveguide structure, the fluid structure must be protected against the adhesive, which is typically of low viscosity, by a structured nickel plate or a similarly suitable device 6. The nickel plate is produced in accordance with preform production for embossing the fluid/optical structure. It should be ensured here that the shrinkage of the PMMA fluid/optical structure due to the casting process is taken into account. This procedure is known to the person skilled in the art. In order that the nickel plate used for protecting the fluid structure does not adhere to the optical adhesive, about 0.1% by weight of palmitic acid is added to the adhesive as release agent. The adhesive should be introduced either through fill and vent holes in the nickel plate, but openings in the substrate have also proven suitable. The adhesive is typically cured either photochemically or thermally. Adhesive projecting at the fill openings (openings in the nickel plate) must be removed after curing by brief polishing. If the fill openings are located in the substrate, re-working is not necessary, but the waveguide losses are then increased slightly since the waveguide walls have cut-outs with the diameter of the openings.

In FIG. 5, the waveguide is in direct contact with the fluid medium and can be connected to the optical source and detector more easily outside the chip. It is disadvantageous that the structured nickel plate used for protection of the fluid structure must have an outer edge in order to prevent the adhesive from flowing out of the waveguide trench (section A in FIG. 5). The waveguide trench shown in FIG. 6 ends from about 20 to 50 μm before the fluid channel and likewise from about 20 to 50 μm before the outer edge of the chip. Filling of a waveguide trench of this type is substantially unproblematic. It is disadvantageous in this arrangement that additional waveguide/substrate interfaces have an adverse effect on the optical properties due to additional Fresnel losses.

Alternatively, a trench which is filled with a relatively high-refractive-index polymer is embossed into the cover in a casting process. The fluid structures are cast into a substrate in a separate process step. Filling of the trench embossed into the cover is significantly simpler than filling of the waveguide trenches embossed into the substrate since there is no need to protect a fluid structure against the optical adhesive. This design variant is therefore preferred.

The mould insert for the casting method is produced, depending on the channel cross section and waveguide cross section, using lithographic and/or micromechanical production techniques and etching of, for example, silicon. It is also possible to use other microstructuring techniques. The main requirement of the structures, in particular the optical structures, is for low roughness of the surface.

On use of lithographic methods (for example multiple exposure in AR 3220, Allresist Berlin), waveguide side-wall roughness values of Rₐ=50 nm and waveguide base roughness values of Rₐ=20 nm are achieved after copying the structure into nickel (nickel sulfamate electrolyte) and casting in PMMA (hot-embossing method in PMMA XT, Röhm). Structures produced by precision mechanical methods (diamond milling cutter in Ms 58 brass with high-speed spindle) have roughness values of at least Rₐ=50 nm and typically about Rₐ=130 nm.

The waveguide material used is, for example, a Norland (Brunswick, USA) adhesive (NOA 61). This has a refractive index of 1.559 (589 nm, 20° C.). The numerical aperture (NA) of the waveguide on use of PMMA (n_{D}²⁰=1.491) as cover or substrate material is 0.46, which corresponds to an aperture angle of about 54°. This adhesive, which has an attenuation of <0.2 dB/cm in the visible wavelength range, is cured photochemically using a UV source (Osram HQL 125 W mercury vapour lamp). For this purpose, the substrate material or cover material used must be transparent at wavelengths of >350 nm. The optical losses of the waveguides produced are typically between 0.2 and 0.6 dB/cm at a wavelength of 633 nm.

The components of the analysis unit, typically the substrate and cover, are subsequently joined to one another. One possible method is the method disclosed in DE 19846958. However, this can only be employed if both the material of the cover and substrate and the waveguide material can be bonded by this method. EP 0 738 306 describes a bonding method in which a dissolved thermoplastic is spin-coated onto the structured polymer substrate. This thermoplastic has a lower melting point than the parts to be bonded. Thermal bonding of cover and substrate is carried out at 140° C. If waveguides are to be installed in analysis units to be produced by this method, the refractive index of this “bonding” thermoplastic must be lower than the refractive index of the waveguide. The temperature stability of the waveguide material must also be greater than that of the “bonding” thermoplastic. This represents a considerable disadvantage of this technology regarding the material properties to be matched to one another.

WO 97/38300 describes a process in which a cover coated with PDMS (polydimethylsiloxane) is bonded to a polyacrylate-based channel structure. Owing to the low refractive index of PDMS (n_{D}²⁰=1.41), this process is mainly suitable for sealing structures containing waveguides based on materials having higher refractive indices without impairing the waveguide properties. All functional constituents, i.e. waveguides, open microstructures and electrodes, must then be combined in, for example, the substrate since, for example, electrodes would otherwise be electrically insulated by the spin-coating of PDMS.

The components are preferably joined to one another by a bonding process described in DE 199 27 533 and WO 00/77509. This process is particularly advantageous since all sides of the channel system can consist of the same material and no interfering adhesive enters the channel or coats any integrated electrodes (for example thin-film electrodes, means for applying electrodes are disclosed in DE 199 27 533 and WO 00177509) or the end faces of the optical waveguides. This enables particularly sensitive and readily reproducible separations and analyses to be carried out. In this process, an adhesive is preferably applied firstly to the microstructured component at the points where no structuring is present. The layer thickness is between 0.5 and 10 μm, preferably between 3 and 8 μm. The application is typically carried out by means of full-area roller application known from printing technology. The adhesive used must not dissolve the surface of the components, or only do so to a very slight extent, in order that any electrodes present are not detached or interrupted by the adhesive during the bonding process. The adhesive used is therefore preferably the product NOA 72, thiol acrylate, from Norland, New Brunswick N.J., USA. This adhesive is cured photochemically. However, other types of adhesive, such as, for example, thermally curing adhesives, which satisfy the above-mentioned prerequisites can also be used for the process.

After application of the adhesive, the second component, where appropriate with the thin-film electrodes, is positioned in a suitable manner with respect to the substrate, for example, on an exposure machine, and the two components are brought into contact with a suitable pressure. Preference is given to the use of strong glass plates as pressing surface, enabling photochemical curing of the adhesive to be carried out directly by irradiation with an Hg lamp (emission wavelength 366 nm).

The positioning of the cover on the substrate for the adhesive bonding operation can typically be carried out visually with manual checking, passively and mechanically with the aid of a snap-fit device, optically and mechanically with the aid of optical adjustment marks or electrically and mechanically with the aid of electrical marks (contacts).

In another preferred embodiment, the component preferably provided with electrodes is wetted with the adhesive in the areas which, when the two components are placed together, are not above a channel or have to be provided with electrical contacts. A process which is known in printing technology (pad printing), for example, is used for this purpose. The component with the channel structures is subsequently positioned with respect to its counterpart in a suitable manner and pressed on. The curing is carried out as described above.

If the curing process of the adhesive is carried out outside the adjustment device used for positioning of cover and substrate, the metallised cover and the substrate can, after they have been adjusted with respect to one another, initially be tacked by means of laser welding. The assembly is then removed from the adjustment device, and the adhesive used is cured in a separate exposure apparatus or an oven. This procedure means an increase in the process speed and simplification since the curing no longer has to be carried out in the adjustment device.

Since the thermoplastic materials preferably used are substantially transparent to laser light in the visible and near infrared wavelength range, laser welding in this wavelength range requires an absorber layer for absorption of the optical power at the cover/substrate interface. This absorber layer is applied at the same time as the application of the power or detector electrodes. For example, the electrode cover can additionally be sputtered at further points with a noble-metal layer as absorber layer during sputtering of the electrodes with noble metal.

The welding of an electrode cover provided with platinum electrodes with a thickness of 200 nm, which thus also includes additional platinum areas for absorption of the laser power, to a substrate (both made from PMMA) is carried out with diode laser radiation (wavelength mixture of 808, 940 and 980 nm) with a power of 40 watts and a focus diameter of 1.6 mm. The platinum layer is destroyed during the welding.

2.) Production by Means of Multicomponent Injection Moulding

Positioning of the optical structure against the fluid structure using multicomponent injection moulding is a potentially very inexpensive production variant.

Multicomponent injection moulding enables both the microfluidic structures and the optical waveguides for connection to an optical unit outside the analysis unit to be produced in a single process step. To this end, firstly the fluid structure is injection-moulded from a standard injection-moulding material (for example PMMA VQ 101 S, n_{D}²⁰=1.491). The optical waveguide structure, which consists of a plastic having a higher optical refractive index compared with the base material (for example SAN, n_{D}²⁰=1.568, LURAN 358N, BASF), is injection-moulded onto this fluid structure within the same process.

Significantly easier to produce in this technology is the waveguide structure integrated into the cover. In this case, a planar cover is firstly cast in a first cycle. The channel to be filled with the relatively high-refractive-index polymer (FIG. 3) is filled after pulling a core puller with the dimensions of the waveguide. The sprue is removed by sawing and, if necessary, brief polishing.

In a second variant (FIG. 4), a discontinuous waveguide structure is injection-moulded onto a planar cover. This waveguide structure is complementary with a waveguide structure embossed into the substrate.

After the components, which can likewise include thin-film electrodes, have been assembled using the above-mentioned processes, the arrangement of waveguide to fluid structure shown in FIGS. 1 and 4 is achieved.

3.) Combination of Embossing Technology and Lamination Technology

Another production technology for the production of waveguides located on a planar plastic surface (cover corresponding to FIG. 4) consists in the combination of embossing technology and lamination technology.

To this end, a relatively high-refractive-index polymer is, in a first process step, pressed into a trench in a metallic mould insert (for example made of nickel) which corresponds to the waveguide structure. In a second process step, a polymer film having a lower optical refractive index is laminated onto the waveguide polymer located in the trenches. Pulling of this combination out of the trench results in a cover with waveguides, shown in FIG. 4, which may additionally be provided with thin-film electrodes. The advantage of this technology over injection-moulding technology consists in that subsequent working of the waveguide end faces (removal of the sprue to give a smooth waveguide end face) is unnecessary.

Another production technology consists in filling the trenches with the waveguide structure with an adhesive of high optical refractive index, which is polymerised either thermally or photochemically. When curing is complete, a polymer film which has a lower refractive index than the polymer located in the trenches is likewise laminated onto this polymer located in the trenches. Pulling of this combination out of the trench likewise results in the cover with waveguides shown in FIG. 4.

In all cover production processes, the cover is subsequently bonded to the substrate in a liquid-tight manner in accordance with the processes described above.

4.) Generation of the Waveguides by Irradiation

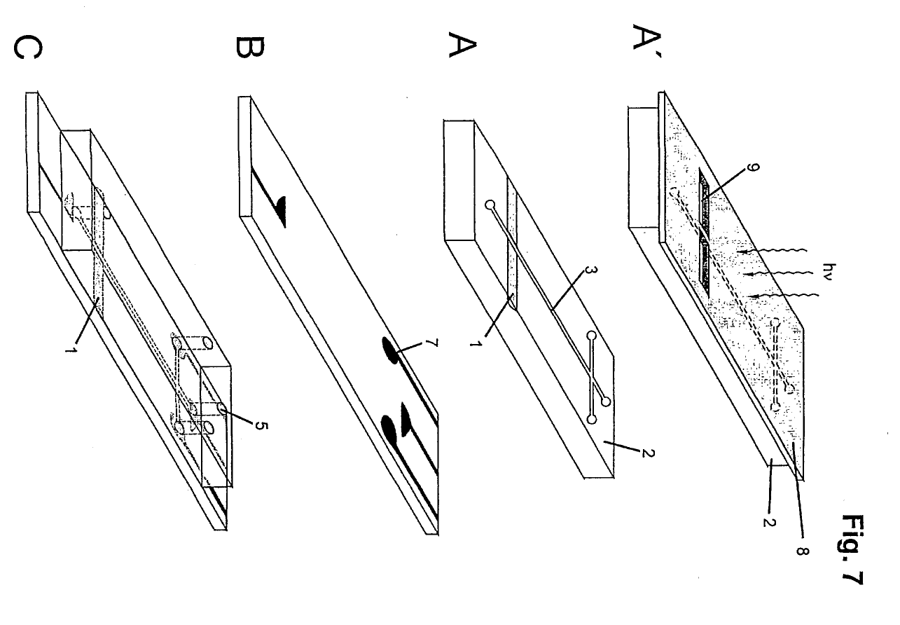

The waveguides are generated by irradiation of defined areas either in the substrate (FIG. 7) or in the cover. To this end, the substrate or cover is exposed to intense UV radiation through a metallic hole mask 8 which contains cut-outs 9 having the dimensions of light waveguides to be produced (part A′ of the figure). The theoretical and experimental basis for this technology has been summarised, for example, in W. F. X. Frank, B. Knödler, A. Schösser, T. K. Strempel, T. Tschudi, F. Linke, D. Muschert, A. Stelmaszyk, H. Strack, “Waveguides in polymers,” SPIE 2290, 125-132, 1994 or A. Schösser, B. Knödler, T. Tschudi, W. F. X. Frank, A. Stelmaszyk, D. Muschert, D. Rück, S. Brunner, F. Pozzi, S. Morasca, C. de Bernardi, “Optical components in polymers,” SPIE 2540, 110-117,1995.

The advantage of this technology is that it is simple to carry out, but the waveguide quality is significantly worse than in the processes mentioned above. The depth of the waveguides can be determined via the irradiation time with, for example, a low-pressure mercury lamp (TMN 15, Heraeus Noblelight), but is typically only a few microns. The width of the waveguides is determined by the slot width in the masks. Owing to the only small refractive-index range produced of <0.01, the numerical aperture of the waveguides produced is only small. In addition, the waveguide attenuation of about 1.5 dB/cm at 633 nm is very high.

5.)

The insertion of precise, for example polycarbonate, film pieces into trenches provided for this purpose, which are preferably embossed into the PMMA substrate or the PMMA cover, results in the formation of optical waveguides. On use of PC films having n_{D}²⁰=1.590 (Europlex PC, Otto Wolff, Bochum) and PMMA as substrate or cover material, an NA of 0.55 arises. Cutting with a wafer saw or embossing of polycarbonate results in films having sufficiently low roughness values of Rₐ≈120 nm). Embedding of the film pieces in PMMA using an adhesive of high optical refractive index, such as NOA 72 (Norland, n_{D}²⁰=1.56), further reduces the roughness values from an optical point of view. Precise positioning of the film in the trenches is ensured by the trench structure itself and a lateral stop with an accuracy of <8 μm. The optical insertion losses of waveguides produced in this way are about 0.5 dB/cm at a wavelength of 633 nm.

Combination of these waveguide production technologies with the production technology for microfluidic analysis units enables all common optical detection methods based on absorption, scattering, refraction and on optical emission, such as, for example, luminescence or fluorescence, to be achieved on these analysis units. The optical system, which is generally expensive, is thus separated from the planar analysis unit, which is designed, for example, as a disposable article (plastic chip). The supply and output of optical power to and from defined areas of the fluid structure can be achieved in an inexpensive manner.

The typically planar microfluidic components are preferably used in the area of chemical and biochemical analysis. Integration of optical waveguides is also suitable for the detection of optical emission or absorption in miniaturised, polymer-based analysis components based, for example, on plasma processes.

Even without further comments, it is assumed that a person skilled in the art will be able to utilise the above description in its broadest scope. The preferred embodiments and examples should therefore merely be regarded as descriptive disclosure which is absolutely not to be regarded as limiting in any way.

The complete disclosure content of all applications, patents and publications mentioned above and below, in particular the corresponding application DE 10029946, filed on Jun 17, 2000, is incorporated into this application by way of reference.

1. Planar, microstructured, miniaturised, polymer-based analysis unit containing integrated optical polymer light waveguides.

2. Planar, microstructured, miniaturised analysis unit according to claim 1, characterised in that the substrate (2) and cover (4) of the analysis unit consist of PMMA.

3. Planar, microstructured, miniaturised analysis unit according to one of claims 1 and 2, characterised in that the substrate is microstructured and the cover has thin-film electrodes.

4. Process for the production of microstructured, miniaturised, polymer-based analysis units containing integrated optical polymer light waveguides, characterised in that
a) at least two suitable polymer-based components are provided;
b) optical polymer light waveguides are integrated into at least one component;
c) the components are assembled to form an analysis unit.

5. Process according to claim 4, characterised in that the integration of the polymer light waveguides in step b) is carried out by multicomponent injection moulding.

6. Process according to one of claims 4 and 5, characterised in that the assembly of the components in step c) is carried out by
i) wetting at least one component with adhesive in such a way that, after assembly of the components, the interior of the channel system produced by the microstructuring is not covered with adhesive;
ii) adjusting the components;
iii) pressing the components together;
iiii) curing the adhesive.

7. Use of the microstructured, polymer-based analysis units corresponding to one of claims 1 to 3 for the optical analysis of samples.
